(19) United States
(12) Patent Application Publication
(10) Pub. No.: US 2015/0134715 A1
(43) Pub. Date: May 14, 2015

(54) Coordinates Conversion Method Of Conservative Physical Parameters From Latitude-Longitude Coordinates System To Rotated Cubed-Sphere Coordinates System And Hardware Device Performing The Same

(71) Applicant: Korea Institute of Atmospheric Prediction Systems, Seoul (KR)

(72) Inventors: Ki-Hwan KIM, Seoul (KR); Young-Su LEE, Seoul (KR); Seol-Eun SHIN, Seoul (KR)

(21) Appl. No.: 14/080,037

(22) Filed: Nov. 14, 2013

(30) Foreign Application Priority Data
Nov. 8, 2013 (KR) 10-2013-0135691

(51) Int. Cl. G06F 5/00

(52) U.S. Cl. CPC G06F 5/00
USPC 708/442

(57) ABSTRACT

A method of converting coordinates of a physical quantity from a latitude-longitude coordinates system to a rotated cubed-sphere coordinates system is disclosed. The method is performed in a hardware device including a computation part and a memory. A plurality of latitude-longitude grid areas which overlap a cubed-sphere grid area is determined. An overlapping area between the cubed-sphere grid area and the latitude-longitude grid areas is computed.

### TECHNICAL FIELD

Example embodiments of the invention relate to a coordinates conversion method for a numerical weather prediction model and a hardware device performing the same. More particularly, example embodiments of the invention relate to a coordinates conversion method of conservative physical parameters from a latitude-longitude coordinates system to a rotated cubed-sphere coordinates system and a hardware device performing the same.

### DESCRIPTION OF THE RELATED ART

A numerical weather prediction (“NWP”) model is a mathematical model to compute a plurality of equations including dynamic equations and physical parameterization equations of atmosphere and ocean in order to predict a future weather condition from current or past weather conditions. The NWP model may include a dynamic core part which is important to compute the dynamic equations. The dynamic core part may describe physical quantities such as e.g., wind, temperature, pressure, humidity, entropy, etc, as primitive equations including a plurality of partial differential equations. The dynamic core part may numerically solve a solution of the primitive equations.

Information on positions of variables in the primitive equations may be required to compute the primitive equations as well as a computation method for the partial differential equations. The information on positions of variables in the primitive equations may be acquired using a spherical coordinates system to indicate horizontal and vertical positions on the Earth. For example, a conventional latitude-longitude coordinates system may be used to indicate horizontal positions of the variables. Also, a vertical coordinates system such as, a pressure height, or a sea surface height may be used to indicate vertical positions of the variables. The computation method for the partial differential equations may include a spectral element method which is configured to divide a whole computational space into a plurality of element spaces.

Technologies have been developed to use a cubed-sphere grid system to compute the numerical solution of the partial differential equations. The cubed-sphere grid system may reduce a difference between grid point distribution in a polar region and that in an equatorial region.

### CONTENT OF THE INVENTION

### Technical Object of the Invention

One or more example embodiment of the invention provides a coordinates conversion method of conservative physical parameters from a latitude-longitude coordinates system to a rotated cubed-sphere coordinates system capable of automatically computing a numerical solution of a numerical weather prediction model in a desired geographical region.

Also, another example embodiment of the invention provides a hardware device performing the coordinates conversion method of conservative physical parameters from a latitude-longitude coordinates system to a rotated cubed-sphere coordinates system.

### Construction and Operation of the Invention

In an example embodiment of a coordinates conversion method of conservative physical parameters from a latitude-longitude coordinates system to a rotated cubed-sphere coordinates system, a plurality of latitude-longitude grid areas which overlap a cubed-sphere grid area is determined. A plurality of vertex areas is determined among the latitude-longitude grid areas. The vertex areas include first vertex points of the cubed-sphere grid area respectively. First intersection points at which a latitude grid line or a longitude grid line crosses a cubed-sphere grid line are determined. The first intersection points are located between the vertex areas. A plurality of boundary latitude-longitude grid areas is determined among the latitude-longitude grid areas. The boundary latitude-longitude grid areas are directly adjacent to each of the first intersection points. A plurality of inner latitude-longitude grid areas is determined among the latitude-longitude grid areas. The inner latitude-longitude grid areas are surrounded by the vertex areas and the boundary latitude-longitude grid areas. First coordinates of the vertex points of the cubed-sphere grid area defined in a cubed-sphere coordinates system are converted into second coordinates defined in a three-dimensional Cartesian coordinates system. The second coordinates defined in the three-dimensional Cartesian coordinates system are converted into third coordinates defined in the latitude-longitude coordinates system. A parameter is defined by a difference between one of values of the third coordinates and a latitude value of an equi-latitude grid line or a longitude value of an equi-longitude grid line. The first intersection points are determined by points which make the parameter close to zero in a predetermined error range respectively. An overlapping area between the cubed-sphere grid area and the latitude-longitude grid areas is computed. The method is performed in a hardware device including a computation part and a memory electrically connected to the computation part. The computation part includes a plurality of computing units.

In an example embodiment, second intersection points at which the latitude grid line or the longitude grid line crosses the cubed-sphere grid line may be determined. The second intersection points may be located in one of the latitude-longitude grid areas. Second vertex points of the one of the latitude-longitude grid areas may be determined. The second vertex points may be located within the cubed-sphere grid area. A line integral along a closed line which connects the second intersection points and the second vertex points may be numerically computed in a clockwise direction or a counterclockwise direction.

In an example embodiment, at least one of the first intersection points may coincide with one of the second intersection points.

In an example embodiment, coordinates of a physical quantity represented in the cubed-sphere coordinates system may be converted into coordinates in a rotated cubed-sphere coordinates system. The rotated cubed-sphere coordinates system may be rotated on one of a first axis, a second axis and a third axis which define the cubed-sphere coordinates system.

In an example embodiment, the rotated cubed-sphere coordinates system may be rotated on the first axis in a first rotation and further rotated on a fourth axis to which the second axis changes by the first rotation.

In an example embodiment of a hardware device performing the coordinates conversion method of conservative physical parameters from a latitude-longitude coordinates system to a rotated cubed-sphere coordinates system, the hardware device includes a computation part and a memory electrically connected to the computation part. The computation part is configured to determine a plurality of latitude-longitude grid areas overlapping a cubed-sphere grid area and to compute overlapping areas between the cubed-sphere grid area and the latitude-longitude grid areas. The computation part may be further configured to determine a plurality of vertex areas among the latitude-longitude grid areas, first intersection points at which a latitude grid line or a longitude grid line crosses a cubed-sphere grid line, a plurality of boundary latitude-longitude grid areas among the latitude-longitude grid areas and a plurality of inner latitude-longitude grid areas among the latitude-longitude grid areas. The vertex areas include first vertex points of the cubed-sphere grid area respectively. The first intersection points are located between the vertex areas. The boundary latitude-longitude grid areas are directly adjacent to each of the first intersection points. The inner latitude-longitude grid areas are surrounded by the vertex areas and the boundary latitude-longitude grid areas. The first intersection points are determined by points which make a parameter close to zero in a predetermined error range respectively. The parameter is defined by a difference between one of values of second coordinates and a latitude value of an equi-latitude grid line or a longitude value of an equi-longitude grid line. The second coordinates are defined in the latitude-longitude coordinates system and are converted from first coordinates of the vertex points of the cubed-sphere grid area defined in a cubed-sphere coordinates system via a three-dimensional Cartesian coordinates system.

In an example embodiment, the computation part may be further configured to determine second intersection points at which the latitude grid line or the longitude grid line crosses the cubed-sphere grid line and second vertex points of the one of the latitude-longitude grid areas. The computation part may be further configured to numerically compute a line integral along a closed line which connects the second intersection points and the second vertex points in a clockwise direction or a counterclockwise direction. The second intersection points may be located in one of the latitude-longitude grid areas. The second vertex points may be located within the cubed-sphere grid area.

In an example embodiment, the computation part may be further configured to convert coordinates of a physical quantity represented in the cubed-sphere coordinates system into coordinates in a rotated cubed-sphere coordinates system. The rotated cubed-sphere coordinates system may be rotated on one of a first axis, a second axis and a third axis which define the cubed-sphere coordinates system.

In an example embodiment, the rotated cubed-sphere coordinates system may be rotated on the first axis in a first rotation and further rotated on a fourth axis to which the second axis changes by the first rotation.

In an example embodiment, the computation part may include a slave computation part and a master computation part. The computation part may include a plurality of slave computing units. The master computation part may be configured to allocate a plurality of work loads to the slave computing units. The master computation part may be configured to allocate a first work load for computing overlapping areas between first latitude-longitude grid areas and a first cubed-sphere grid area to a first slave computing unit. The master computation part may be further configured to allocate a second work load for computing overlapping areas between second latitude-longitude grid areas and a second cubed-sphere grid area to a second slave computing unit.

In an example embodiment, the master computation part may be further configured to allocate a third work load for computing overlapping areas between third latitude-longitude grid areas and a third cubed-sphere grid area to the first slave computing unit if the first slave computing unit finishes the first work load while the second slave computing unit processes the second work load.

### Effect of the Invention

According to one or more example embodiment of the coordinates conversion method of conservative physical parameters from a latitude-longitude coordinates system to a rotated cubed-sphere coordinates system and the hardware device performing the same, a first value of a physical quantity defined in a conventional latitude-longitude coordinates system in a numerical weather prediction model may be conservatively converted to a second value of the physical quantity defined in a standard cubed-sphere coordinates system and then may be conservatively converted to a third value of the physical quantity defined in a rotated cubed-sphere coordinates system, thereby capable of automatic computation of a numerical solution of the numerical weather prediction model in a desired geographical region.

### BRIEF EXPLANATION OF THE DRAWINGS

The above and other features and advantages of the invention will become more apparent by describing in detailed example embodiments thereof with reference to the accompanying drawings, in which:

FIG. 1 is a block diagram illustrating a hardware device performing a coordinates conversion method of conservative physical parameters from a latitude-longitude coordinates system to a rotated cubed-sphere coordinates system according to an example embodiment of the invention;

FIG. 2 is a perspective view illustrating a conventional latitude-longitude coordinates system which may be used in the hardware device of FIG. 1;

FIG. 3 is a perspective view illustrating a standard cubed-sphere coordinates system which may be converted from the latitude-longitude coordinates system of FIG. 2;

FIG. 4A is an enlarged perspective view illustrating a geographical region overlapping the latitude-longitude coordinates system with the standard cubed-sphere coordinates system of FIG. 3;

FIG. 4B is an enlarged perspective view illustrating a geographical region with grid lines in the standard cubed-sphere coordinates system of FIG. 3;

FIG. 5A is an enlarged perspective view illustrating a geographical region with grid center points and grid boxes in the latitude-longitude coordinates system of FIG. 4A overlapping with the standard cubed-sphere coordinates system of FIG. 4B;

FIG. 5B and FIG. 5C are perspective views illustrating geographical regions with grid center points and grid boxes having different overlapping areas in the latitude-longitude coordinates system and the standard cubed-sphere coordinates system;

FIG. 6A, FIG. 6B, FIG. 6C and FIG. 6D are perspective views conceptually illustrating a first step to a fourth step performed in a coordinates conversion method of conservative physical parameters from a latitude-longitude coordinates system to a rotated cubed-sphere coordinates system according to an example embodiment of the invention;

FIG. 7 is a perspective view illustrating intersection points of a latitude-longitude grid box with a cubed-sphere grid box in a coordinates conversion method of conservative physical parameters from a latitude-longitude coordinates system to a rotated cubed-sphere coordinates system according to an example embodiment of the invention;

FIG. 8A, FIG. 8B, FIG. 8C and FIG. 8D are perspective views illustrating intersection points of a latitude-longitude grid line with a cubed-sphere grid line in a coordinates conversion method of conservative physical parameters from a latitude-longitude coordinates system to a rotated cubed-sphere coordinates system according to an example embodiment of the invention;

FIG. 9A, FIG. 9B and FIG. 9C are perspective views conceptually illustrating a fifth step to a seventh step performed in a coordinates conversion method of conservative physical parameters from a latitude-longitude coordinates system to a rotated cubed-sphere coordinates system according to an example embodiment of the invention;

FIG. 10 is a perspective view illustrating a rotated cubed-sphere coordinates system converted from a latitude-longitude coordinates system according to an example embodiment of the invention;

FIG. 11 is a perspective view illustrating axes of a rotated cubed-sphere coordinates system converted from a standard cubed-sphere coordinates system according to an example embodiment of the invention;

FIG. 12 is a block diagram illustrating a computation part in a hardware device performing a coordinates conversion system of conservative physical parameters from a latitude-longitude coordinates system to a rotated cubed-sphere coordinates system according to an example embodiment of the invention;

FIG. 13A is a perspective view illustrating a distribution of an atmospheric physical parameter using a conventional latitude-longitude coordinates system; and

FIG. 13B is a perspective view illustrating a distribution of an atmospheric physical parameter using a rotated cubed-sphere coordinates system converted from a latitude-longitude coordinates system according to an example embodiment of the invention.

### DETAILED DESCRIPTION OF THE INVENTION

Various example embodiments will be described more fully hereinafter with reference to the accompanying drawings, in which example embodiments are shown. Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or features relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in further detail with reference to the accompanying drawings.

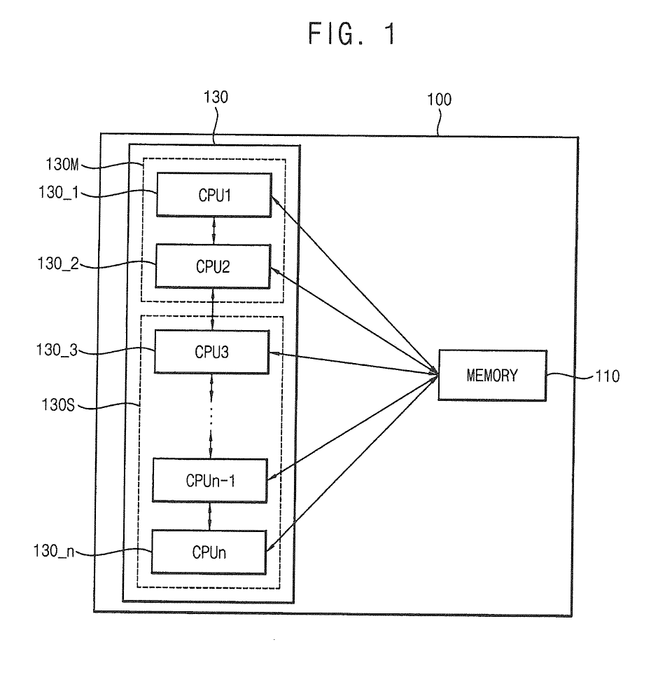

FIG. 1 is a block diagram illustrating a hardware device performing a coordinates conversion method of conservative physical parameters from a latitude-longitude coordinates system to a rotated cubed-sphere coordinates system according to an example embodiment of the invention.

Referring to FIG. 1, a hardware device 100 performing a coordinates conversion method of conservative physical parameters from a latitude-longitude coordinates system to a rotated cubed-sphere coordinates system according to the present example embodiment may include a memory 110 and a computation part 130. The memory 110 may be electrically connected to the computation part 130. For example, the hardware device 100 may include a server including a plurality of central processing unit (CPU) and a buffer memory. The computation part 130 may include a plurality of CPUs (i.e., CPU1 to CPUn). For example, the computation part 130 may include a first CPU 103_1 to an n-th CPU 130_{—}n configured to communicate with one another. For example, the computation part 130 may include thousands of or millions of CPUs.

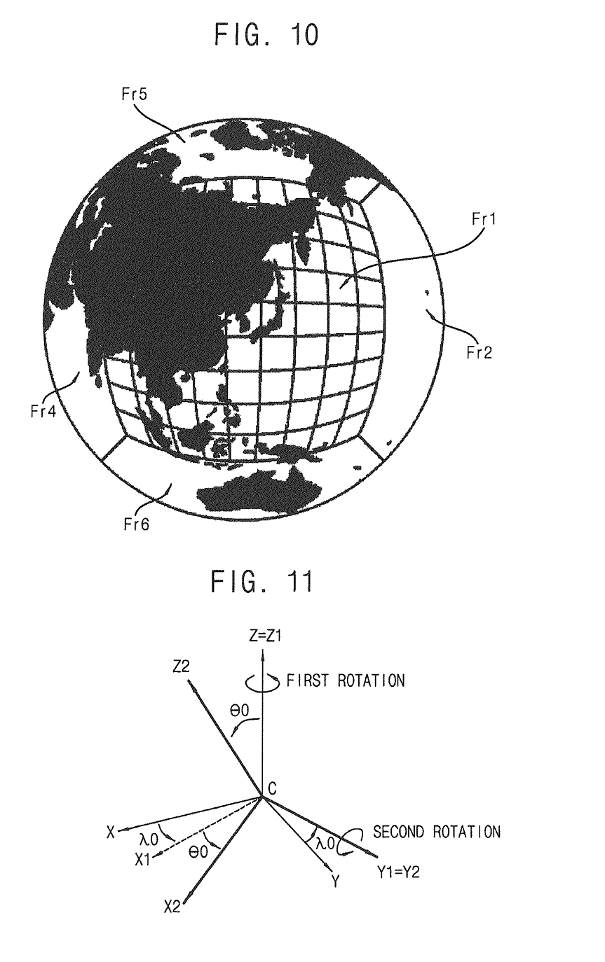

The computation part 130 may include a master computation part 130M and a slave computation part 130S. For example, the master computation part 130M may include the first CPU 130_1 and a second CPU 130_2. For example, the slave computation part 130S may include a third CPU 130_3 to the n-th CPU 130_{—}n. The master computation part 130M and the slave computation part 130S will be described in detail referring to FIG. 12.

The memory 110 may electrically communicate with the computation part 130. For example, the memory 110 may be integrated with the computation part 130 in a desired circuit space.

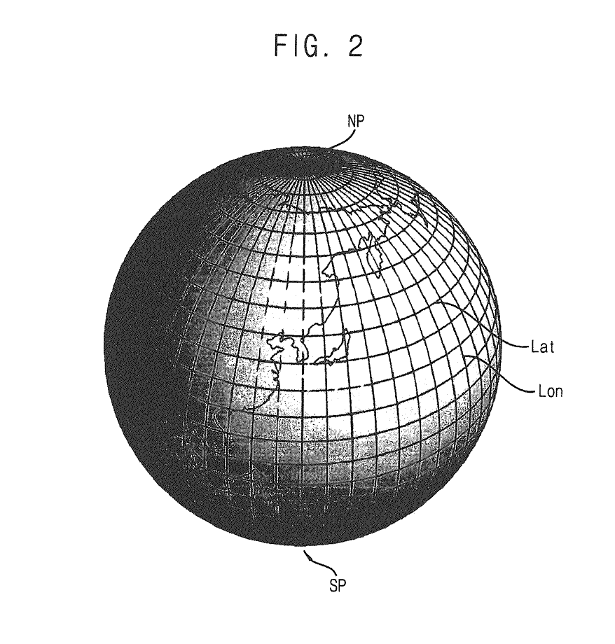

FIG. 2 is a perspective view illustrating a conventional latitude-longitude coordinates system which may be used in the hardware device of FIG. 1.

Referring to FIG. 2, the hardware device 100 may implement a numerical weather prediction model using a conventional latitude-longitude coordinates system. The latitude-longitude coordinates system may include a plurality of longitude lines Lon and a plurality of latitude lines Lat. The longitude lines Lon may be defined by great circles crossing a north pole NP and a south pole SP. The latitude lines Lat may be defined by circles having degrees from zero at an equator to ±90 at the north pole NP or at the south pole SP. For example, the Korean peninsula may include a geographical point located in 127.5 degrees east and 38 degrees north. In a conventional numerical weather prediction model, equations of atmospheric and/or oceanic physical parameters may be numerically computed based on the latitude-longitude coordinates system.

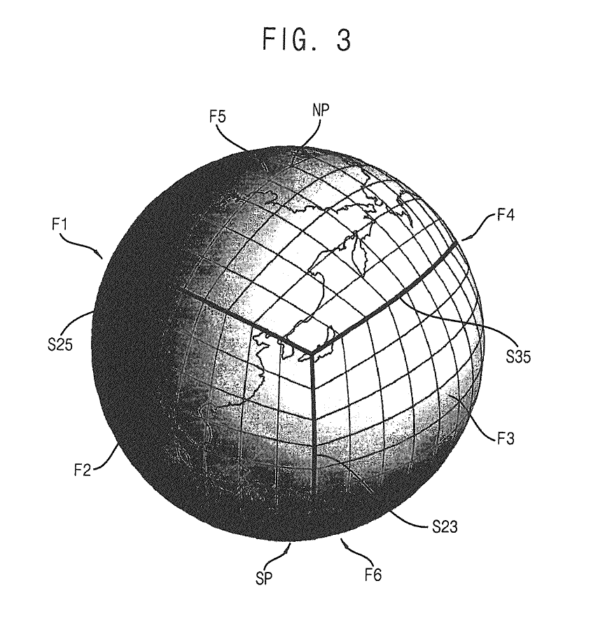

FIG. 3 is a perspective view illustrating a standard cubed-sphere coordinates system which may be converted from the latitude-longitude coordinates system of FIG. 2.

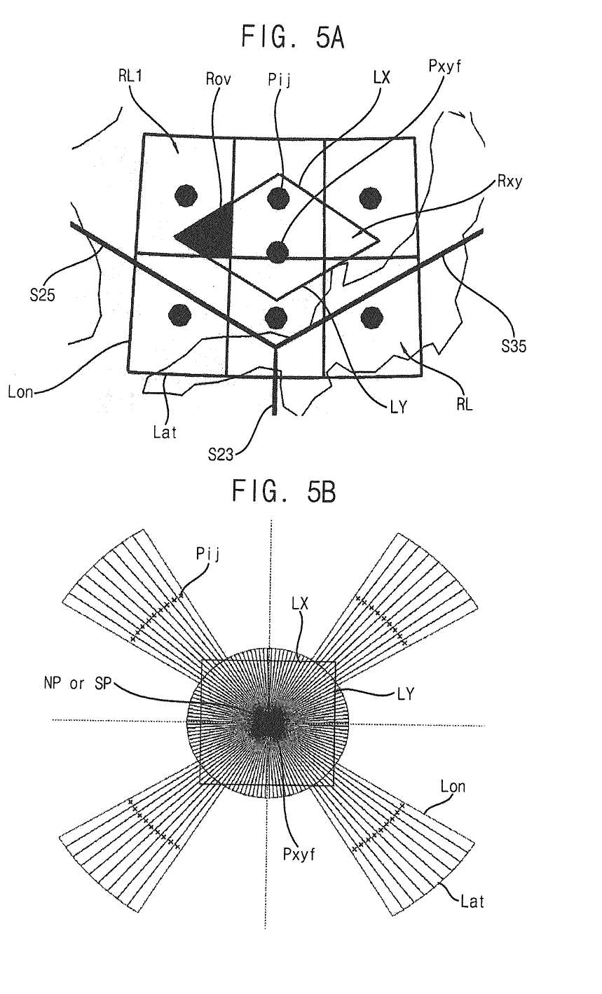

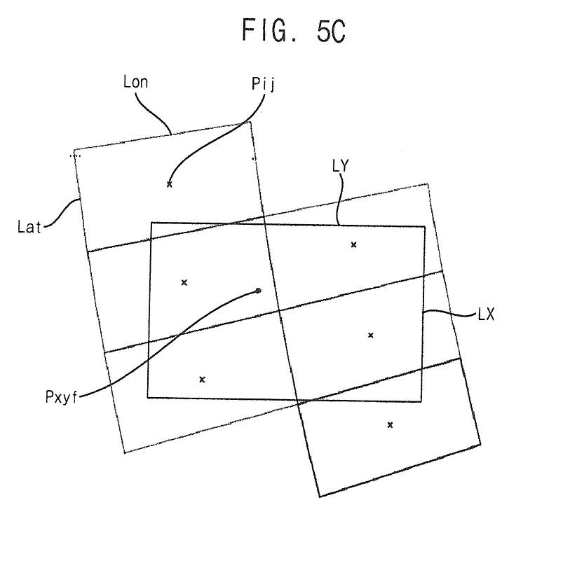

Referring to FIG. 3, a standard cubed-sphere coordinates system may include six faces on the Earth's surface. The standard cubed-sphere coordinates system may include a plurality of abscissa grid lines extending in a first direction and a plurality of ordinate grid lines extending in a second direction which crosses the first direction in each face of the six faces. The first direction may be substantially perpendicular to the second direction on a virtual face of a regular cube within the Earth. For example, the standard cubed-sphere coordinates system may include a first face F1 in which an intersection point of an equator and a prime meridian is centered. The standard cubed-sphere coordinates system may include a second face F2, a third face F3 and a fourth face F4 sequentially disposed adjacent to the first face F1 according to a rotational direction of the Earth. The standard cubed-sphere coordinates system may include a fifth face F5 in which the north pole NP is centered. The standard cubed-sphere coordinates system may include a sixth face F6 in which the south pole SP is centered. Each faces may have a convex shape inflated from the regular cube. If a numerical weather prediction model uses the standard cubed-sphere coordinates system to represent physical parameters of the atmosphere and/or the ocean, a difference of grid point resolution between a polar region and an equatorial region may be reduced while the difference of grid point resolution occurs in the latitude-longitude coordinates system due to a fine resolution in the polar region and a coarse resolution in the equatorial region. Also, intervals between grid points through the Earth's surface may be relatively uniform. A coordinates conversion method of conservative physical parameters from the latitude-longitude coordinates system to the standard cubed-sphere coordinates system according to the present example embodiment will be described in detail referring to FIG. 5A.

Referring to FIG. 3 again, if the Korean peninsula is indicated in the standard cubed-sphere coordinates system, then a first border line S25 between the second face F2 and the fifth face F5 may cross the Korean peninsula in a northwest-southeast direction. Similarly, if the main island of Japan is indicated in the standard cubed-sphere coordinates system, then both a second border line S23 between the second face F2 and the third face F3 and a third border line S35 between the third face F3 and the fifth face F5 may cross the main island of Japan as well as the first border line S25. Accordingly, if atmospheric physical parameters are computed based on the standard cubed-sphere coordinates system, accuracy of a distribution of the physical parameters may reduce in the Korean peninsula and in the main island of Japan due to the first border line S25, the second border line S23 and the third border line S35.

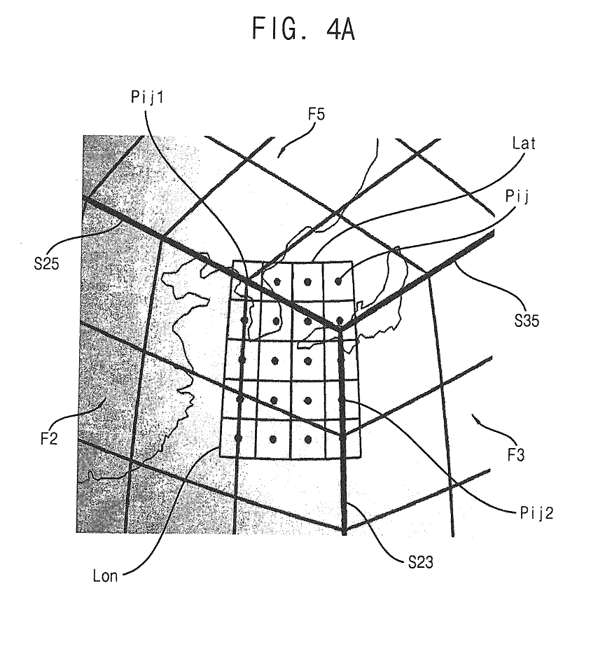

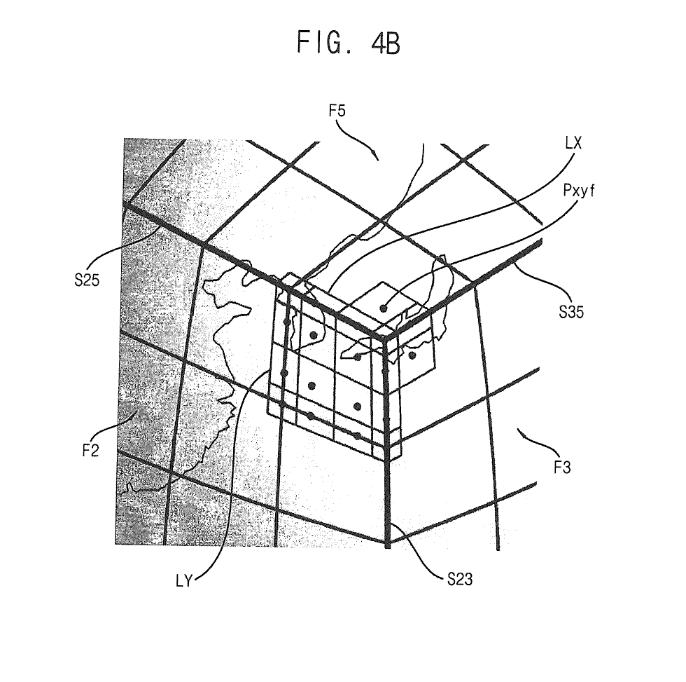

To reduce the decrease in accuracy of the distribution of the physical parameters in north-east Asia region, one of a geographical point may be configured to be centered in a cubed-sphere coordinates system. The coordinates conversion method according to the present example embodiment will be described in detail referring to FIG. 4A to FIG. 11.

FIG. 4A is an enlarged perspective view illustrating a geographical region overlapping the latitude-longitude coordinates system with the standard cubed-sphere coordinates system of FIG. 3.

Referring to FIG. 4A, latitude lines Lat and longitude lines Lon may cross grid lines of the standard cubed-sphere coordinates system in the north-east Asia region. A latitude-longitude center point Pij (hereinafter, “lat-lon center point”) may be located in an area defined by the latitude lines Lat and the longitude lines Lon (hereinafter, “lat-lon area”). For example, the first border line S25 between the second face F2 and the fifth face F5 may cross a first lat-lon center point Pij1 located in a first lat-lon area. Similarly, the second border line S23 between the second face F2 and the third face F3 may cross a second lat-lon center point Pij2. Some grid lines of the standard cubed-sphere coordinates system may cross a lat-lon area without crossing a lat-lon center point.

FIG. 4B is an enlarged perspective view illustrating a geographical region with grid lines in the standard cubed-sphere coordinates system of FIG. 3.

Referring to FIG. 4B, grid lines in the standard cubed-sphere coordinates system may be arranged in desired directions in the north-east Asia region. For example, abscissa grid lines LX (hereinafter, “x-grid lines”) in the second face F2 may extend in a direction similar to a direction in which the first border line S25 extends. Also, ordinate grid lines LY (hereinafter, “y-grid lines”) in the second face F2 may extend in a direction similar to a direction in which the second border line S23 extends. The x-grid lines and the y-grid lines may be defined based on a gnomonic projection. A grid center point Pxyf may be located in an area defined by the x-grid lines and the y-grid lines (hereinafter, “cubed-sphere grid area”). For example, a plurality of grid center points may be located on the first border line S25, the second border line S23 and the third border line S35.

FIG. 5A is an enlarged perspective view illustrating a geographical region with grid center points and grid boxes in the latitude-longitude coordinates system of FIG. 4A overlapping with the standard cubed-sphere coordinates system of FIG. 4B. FIG. 5B and FIG. 5C are perspective views illustrating geographical regions with grid center points and grid boxes having different overlapping areas in the latitude-longitude coordinates system and the standard cubed-sphere coordinates system.

Referring to FIG. 5A, a cubed-sphere grid area Rxy in the standard cubed-sphere coordinates system may overlap, for example, six lat-lon areas RL. A grid center point Pxyf may be located within or on a lat-lon area among the six lat-lon areas RL. A cubed-sphere grid area Rxy may include a lat-lon center point Pij.

It may be required to convert six values of a physical parameter at the lat-lon center points Pij in the lat-lon areas RL to a single value of the physical parameter at the grid center point Pxyf in the cubed-sphere grid area Rxy in order to conservatively convert the physical parameter from the latitude-longitude coordinates system to the standard cubed-sphere coordinates system. The conversion from the six values at the lat-lon center points Pij to the single value at the grid center point Pxyf may be performed by multiplying each of the six values with an overlapping area Rov between the lat-lon area RL and the cubed-sphere grid area Rxy. For example, if “An” denotes an area of a first lat-lon area RL1, and if “Ak” denotes an area of the cubed-sphere grid area Rxy, and if “An,k” denotes an area of the overlapping area Rov between the first lat-lon area RL1 and the cubed-sphere grid area Rxy, then following Equation 1 may be satisfied for the physical parameter to be conservatively converted:

$$\begin{matrix}{\overline{f}}_{k} = \frac{1}{{A}_{k}} {\int }_{{A}_{k}} {f}_{source} d A \\ = \frac{1}{{A}_{k}} {\sum }_{n = 1}^{N} {\int }_{{A}_{n , k}} {f}_{n} d A .\end{matrix} \qquad [ Equation 1 ]$$

Here, “fsource” represents the physical parameter in a local area before converting a coordinates system, and “fn” represents the physical parameter in the first lat-lon area RL1, and “N” represents a number of overlapping areas between two coordinates system, and “ f̅ₖ” represents the physical parameter in the local area after converting the coordinates system. The physical parameter may include a variety of physical quantities, for example, wind, temperature, humidity, entropy, etc. which is used in a numerical weather prediction model.

Accordingly, the number of overlapping areas between lat-lon areas and a cubed-sphere grid area as well as the area of the overlapping areas may be required to conservatively convert the physical parameter from the latitude-longitude coordinates system to the standard cubed-sphere coordinates system.

Although six overlapping areas Rov are illustrated in FIG. 5A between the lat-lon areas and the cubed-sphere grid area, the number and the area of the overlapping areas between lat-lon areas and a cubed-sphere grid area are not limited thereto. For example, the distance between latitude grid lines Lat and/or the distance between the longitude grid lines Lon may be changed according to a geographical region in the latitude-longitude coordinates system. Also the distance between x-grid lines LX and/or the distance between y-grid lines LY may be changed according to a geographical region in the standard cubed-sphere coordinates system. Accordingly, the number and the area of overlapping areas between lat-lon areas and a cubed-sphere grid area may be changed according to a geographical region on the Earth's surface.

For example, referring to FIG. 5B, if a cubed-sphere grid area includes the north pole NP or the south pole SP as a grid center point Pxyf, then a plurality of lat-lon areas (e.g., more than 10 lat-lon areas) may overlap the cubed-sphere grid area.

For example, referring to FIG. 5C, if a cubed-sphere grid area is located in a mid-latitude region in the latitude-longitude coordinates system, then six lat-lon areas may overlap the cubed-sphere grid area. A grid center point Pxyf of the cubed-sphere grid area may be located to be tilted in a direction according to the latitude lines Lat or the longitude lines Lon.

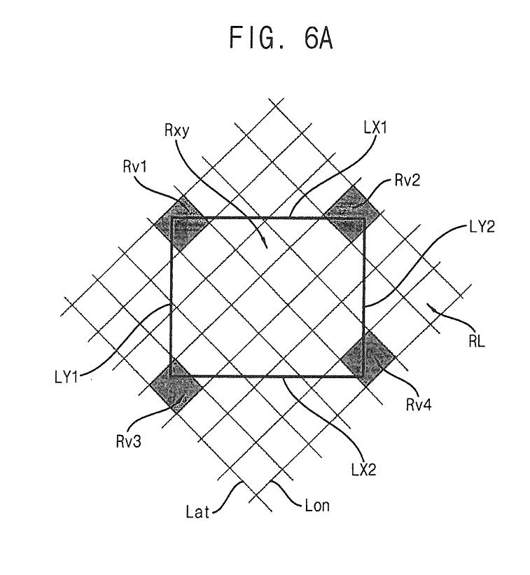

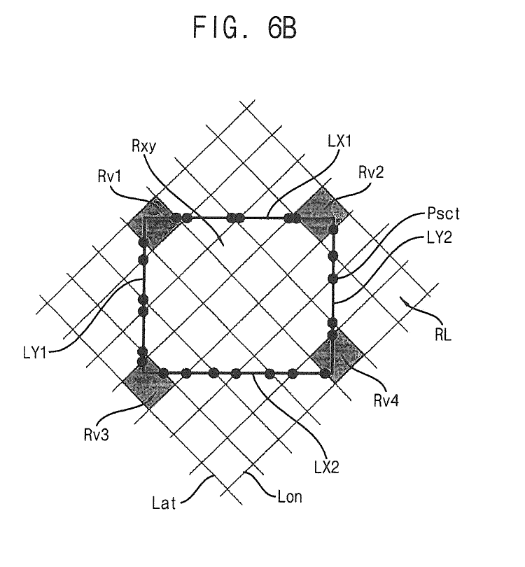

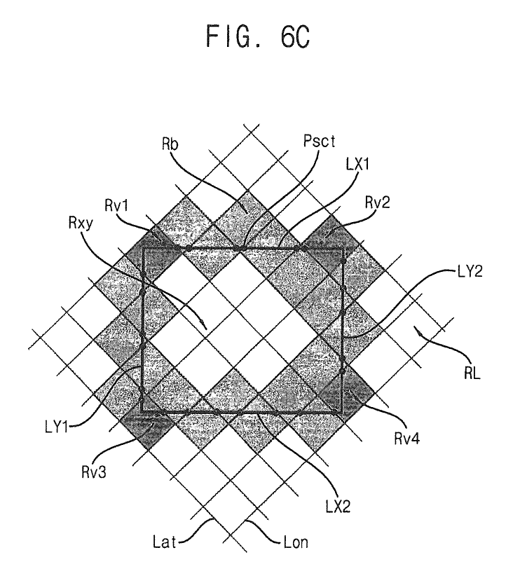

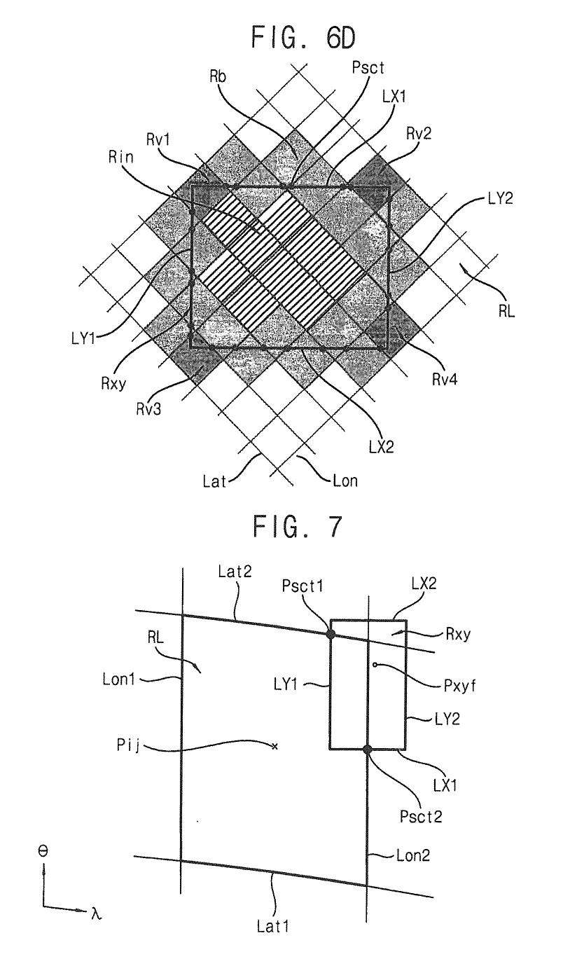

FIG. 6A, FIG. 6B, FIG. 6C and FIG. 6D are perspective views conceptually illustrating a first step to a fourth step performed in a coordinates conversion method of conservative physical parameters from a latitude-longitude coordinates system to a rotated cubed-sphere coordinates system according to an example embodiment of the invention.

Referring to FIG. 6A, in a first step of the coordinates conversion method of conservative physical parameters from the latitude-longitude coordinates system to a rotated cubed-sphere coordinates system according to an example embodiment, one or more lat-lon area including vertices of a cubed-sphere grid area may be determined. For example, if the cubed-sphere grid area Rxy is defined by two x-grid lines LX1 and LX2 and two y-grid lines LY1 and LY2, then at least one lat-lon area (e.g., four lat-lon areas in FIG. 6A) including four intersection points between the LX1, LX2, LY1 and LY2 may be determined. For example, the vertices of the cubed-sphere grid area Rxy may be located within a first vertex area Rv1, a second vertex area Rv2, a third vertex area Rv3 and a fourth vertex area Rv4 respectively.

Although the lat-lon areas RL are determined whether the lat-lon areas RL overlap a single cubed-sphere grid area Rxy in the present example embodiment, a plurality of cubed-sphere grid areas Rxy may be determined whether the cubed-sphere grid areas Rxy overlap a single lat-lon area RL in another example embodiment.

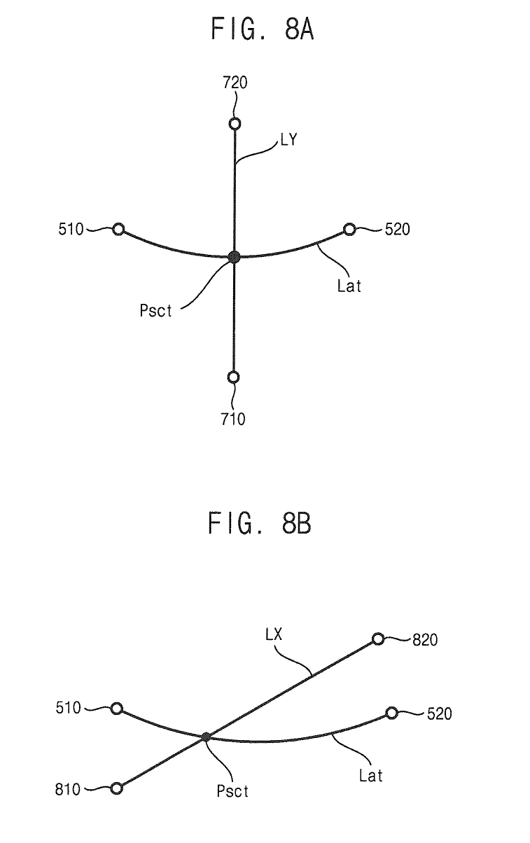

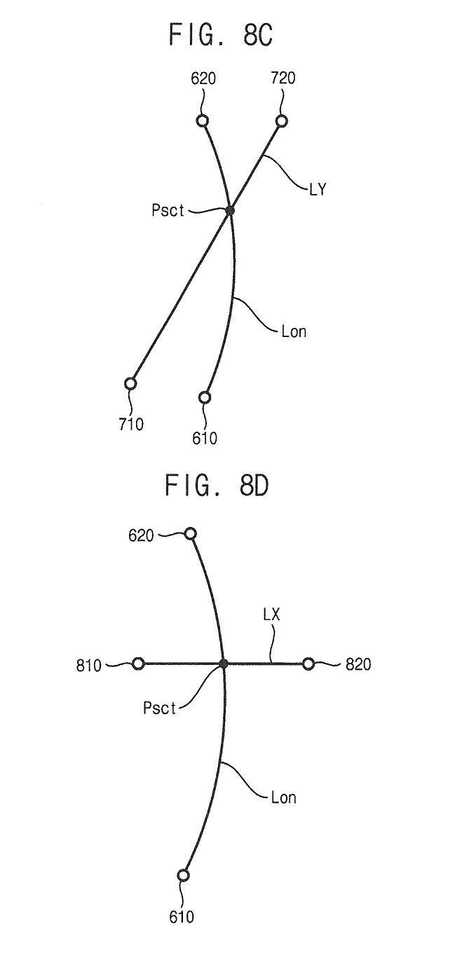

Referring to FIG. 6B, in a second step of the coordinates conversion method of conservative physical parameters from the latitude-longitude coordinates system to a rotated cubed-sphere coordinates system according to an example embodiment, intersection points between the x-grid lines LX1 and LX2, the y-grid lines LY1 and LY2, the latitude lines Lat and the longitude lines Lon may be determined between the first to fourth vertex areas Rv1, Rv2, Rv3 and Rv4. For example, a plurality of intersection points Psct may be determined on the x-grid lines LX1 and LX2 and on the y-grid lines LY1 and LY2. A search method to determine the intersection points Psct may be described in detail referring to FIG. 7 and FIG. 8A to FIG. 8D.

Referring to FIG. 6C, in a third step of the coordinates conversion method of conservative physical parameters from the latitude-longitude coordinates system to a rotated cubed-sphere coordinates system according to an example embodiment, a plurality of lat-lon areas RL directly adjacent to the intersection points Psct may be determined. Accordingly, a plurality of boundary lat-lon areas Rb may be determined. The boundary lat-lon areas Rb may continuously connect the vertex areas Rv1, Rv2, Rv3 and Rv4. A closed area may be defined by the boundary lat-lon areas Rb and the vertex areas Rv1, Rv2, Rv3 and Rv4.

Referring to FIG. 6D, in a fourth step of the coordinates conversion method of conservative physical parameters from the latitude-longitude coordinates system to a rotated cubed-sphere coordinates system according to an example embodiment, closed areas Rin surrounded by the boundary lat-lon areas Rb and the vertex areas Rv1, Rv2, Rv3 and Rv4 may be determined. Accordingly; overlapping areas among the lat-lon areas RL with the cubed-sphere grid area Rxy may be determined by the vertex areas Rv1, Rv2, Rv3 and Rv4, the boundary lat-lon areas Rb and the closed areas Rin. Also, the number of overlapping areas of the lat-lon areas RL with the cubed-sphere grid area Rxy may be determined.

FIG. 7 is a perspective view illustrating intersection points of a latitude-longitude grid box with a cubed-sphere grid box in a coordinates conversion method of conservative physical parameters from a latitude-longitude coordinates system to a rotated cubed-sphere coordinates system according to an example embodiment of the invention.

Referring to FIG. 7, a lat-lon grid area RL defined in the latitude-longitude coordinates system may include a first longitude line Lon1 and a second longitude line Lon2 both extending in a direction to which the latitude θ increases (or decreases). Also, the lat-lon grid area RL may include a first latitude line Lat1 and a second latitude line Lat2 both extending in a direction to which the longitude λ increases (or decreases). A cubed-sphere grid area Rxy defined in a cubed-sphere coordinates system may include a first x-grid line LX1 and a second x-grid line LX2 both extending in a direction to which a y-value is constant. Also, the cubed-sphere grid area Rxy may include a first y-grid line LY1 and a second y-grid line LY2 both extending in a direction to which an x-value is constant.

The lat-lon grid area RL and the cubed-sphere grid area Rxy may intersect at two intersection points. For example, a first intersection point Psct1 may be a point at which the second latitude line Lat2 crosses the first y-grid lane LY1. A second intersection point Psct2 may be a point at which the second longitude line Lon2 crosses the first x-grid line LX1.

FIG. 8A, FIG. 8B, FIG. 8C and FIG. 8D are perspective views illustrating intersection points of a latitude-longitude grid line with a cubed-sphere grid line in a coordinates conversion method of conservative physical parameters from a latitude-longitude coordinates system to a rotated cubed-sphere coordinates system according to an example embodiment of the invention.

Referring to FIG. 8A, an intersection point Psct at which a latitude line Lat crosses a y-grid line LY may be searched as the following.

For example, if the latitude line Lat represents a equi-latitude line of θ=θ0, a first latitude-longitude grid point (hereinafter, “lat-lon grid point”) 510 may have a coordinates of (λ1, θ0) in the latitude-longitude coordinates system. Similarly, a second lat-lore grid point 520 may have a coordinates of (λ2, θ0) in the latitude-longitude coordinates system. If the y-grid line LY represents a equi-x-line of x=x0, a first cubed-sphere grid point 710 may have a coordinates of (x0, y1, F1) which is defined by an x-value, a y-value and a F-value (“F” represents an index of a cubed-sphere face) in the cubed-sphere coordinates system. Similarly, a second cubed-sphere grid point 720 may have a coordinates of (x0, y2, F1). In this case, the intersection point Psct of the latitude line Lat and the y-grid line LY may have a coordinates of (x0, yi, F1), where yi denotes a real number between y1 and y2 (i.e., yiε[y1, y2]). Then, a root finding algorithm may be used in order to find the value of yi. The root finding algorithm may be used with the constant values of x0, F1 and θ0 to find a solution y=yi of a first-order equation.

For example, a cubed-sphere grid point (x, y, F1) in the first face F1 of the cubed-sphere grid coordinates system may be converted to a coordinates of (X, Y, Z) in a three-dimensional Cartesian coordinates system of which an origin is located at the center of the Earth by Equation 2;

$$X = \frac{a R}{\sqrt{{a}^{2} + {x}^{2} + {y}^{2}}} , Y = \frac{x}{a} X , Z = \frac{y}{a} X . \qquad [ Equation 2 ]$$

Here, R represents a radius of the Earth which is a constant value, and “a” represents an arbitrary fixed real number less than the radius of the Earth.

The coordinates of (X, Y, Z) in the three-dimensional Cartesian coordinates system converted from the coordinates (x, y, F1) in the cubed-sphere coordinates system may be converted again to a coordinates of (λ, θ) in the latitude-longitude coordinates system by Equation 3:

$$\frac{Y}{X} = \frac{sin λ}{cos λ} = tan λ \\ \frac{Z}{\sqrt{{X}^{2} + {Y}^{2}}} = \frac{R sin θ}{\sqrt{{R}^{2} {cos}^{2} θ}} = tan θ . \qquad [ Equation 3 ]$$

By using the Equation 2 and the Equation 3 together, the coordinates (x0, yi, F1) of the intersection point Psct may be converted into a coordinates of (λnew, θnew) in the latitude-longitude coordinates system.

If a parameter W is defined by Equation 4:

W=θnew−θ₀, [Equation 4]

then the y-value which makes the parameter W zero (i.e., y=yi) may be determined among a real number interval of [y1, y2] because the intersection point Psct is located on the equi-latitude line of θ=θ0.

As mentioned above, the coordinates (x0, yi, F1) of the intersection point Psct at which the latitude line Lat crosses the y-grid line LY may be automatically determined by defining an operator which has a first-order equation of a variable y making the parameter W zero (or converge to zero) using the Equation 2, the Equation 3 and the Equation 4. For example, the operator may use a Brent method. For example, the yi may be automatically determined by a repetition of numerical computation for the parameter W to be a value sufficiently close to zero within a predetermined error range.

Referring to FIG. 8B, an intersection point Psct at which a latitude line Lat crosses an x-grid line LX may be searched in a similar manner.

For example, if the latitude line Lat represents a equi-latitude line of θ=θ0, a first lat-lon grid point 510 may have a coordinates of (λ1, θ0) in the latitude-longitude coordinates system. Similarly, a second lat-lon grid point 520 may have a coordinates of (λ2, θ0) in the latitude-longitude coordinates system. If the x-grid line LX represents a equi-y-line of y=y0, a third cubed-sphere grid point 810 may have a coordinates of (x1, y0, F1) which is defined by an x-value, a y-value and a F-value in the cubed-sphere coordinates system. Similarly, a fourth cubed-sphere grid point 820 may have a coordinates of (x2, y0, F1). In this case, the intersection point Psct of the latitude line Lat and the x-grid line LX may have a coordinates of (xi, y0, F1), where xi denotes a real number between x1 and x2 (i.e., xiε[x1, x2]). Then, a root finding algorithm may be used in order to find the value of xi. The root finding algorithm may be used with the constant values of y0, F1 and θ0 to find a solution x=xi of a first-order equation.

For example, a cubed-sphere grid point (x, y, F1) in the first face F1 of the cubed-sphere grid coordinates system may be converted to a coordinates of (X, Y, Z) in a three-dimensional Cartesian coordinates system of which an origin is located at the center of the Earth by the above Equation 2.

The coordinates of (X, Y, Z) in the three-dimensional Cartesian coordinates system converted from the coordinates (x, y, F1) in the cubed-sphere coordinates system may be converted again to a coordinates of (λ, θ) in the latitude-longitude coordinates system by the above Equation 3.

By using the Equation 2 and the Equation 3 together, the coordinates (xi, y0, F1) of the intersection point Psct may be converted into a coordinates of (λnew, θnew) in the latitude-longitude coordinates system.

Then, by using the above Equation 4, the x-value which makes the parameter W zero (i.e., x=xi) may be determined among a real number interval of [x1, x2] because the intersection point Psct is located on the equi-latitude line of θ=θ0.

As mentioned above, the coordinates (xi, y0, F1) of the intersection point Psct at which the latitude line Lat crosses the x-grid line LX may be automatically determined by defining an operator which has a first-order equation of variable x making the parameter W zero (or converge to zero) using the Equation 2, the Equation 3 and the Equation 4, For example, the operator may use a Brent method. For example, the xi may be automatically determined by a repetition of numerical computation for the parameter W to be a value sufficiently close to zero within a predetermined error range.

Referring to FIG. 8C, an intersection point Psct at which a longitude line Lon crosses a y-grid line LY may be searched in a similar manner.

For example, if the longitude line Lon represents a equi-longitude line of λ=λ0, a third lat-lon grid point 610 may have a coordinates of (λ0, θ1) in the latitude-longitude coordinates system. Similarly, a fourth lat-lon grid point 620 may have a coordinates of (λ0, θ2) in the latitude-longitude coordinates system. If the y-grid line LY represents a equi-x-line of x=x0, a first cubed-sphere grid point 710 may have a coordinates of (x0, y1, F1) which is defined by an x-value, a y-value and a F-value in the cubed-sphere coordinates system. Similarly, a second cubed-sphere grid point 720 may have, a coordinates of (x0, y2, F1). In this case, the intersection point Psct of the longitude line Lon and the y-grid line LY may have a coordinates of (x0, yi, F1), where yi denotes a real number between y1 and y2 (i.e., yiε[y1, y2]). Then, a root finding algorithm may be used in order to find the value of yi. The root finding algorithm may be used with the constant values of x0, F1 and λ0 to find a solution y=yi of a first-order equation.

For example, a cubed-sphere grid point (x, y, F1) in the first face F1 of the cubed-sphere grid coordinates system may be converted to a coordinates of (X, Y, Z) in a three-dimensional Cartesian coordinates system of which an origin is located at the center of the Earth by the above Equation 2.

The coordinates of (X, Y, Z) in the three-dimensional Cartesian coordinates system converted from the coordinates (x, y, F1) in the cubed-sphere coordinates system may be converted again to a coordinates of (λ, θ) in the latitude-longitude coordinates system by the above Equation 3.

By using the Equation 2 and the Equation 3 together, the coordinates (x0, yi, F1) of the intersection point Psct may be converted into a coordinates of (λnew, θnew) in the latitude-longitude coordinates system.

If a parameter V is defined by Equation 5:

V=λnew−λ₀, [Equation 5]

then the y-value which makes the parameter V zero (i.e., y=ti) may be determined among a real number interval of [y1, y2] because the intersection point Psct is located on the equi-longitude line of λ=λ0.

As mentioned above, the coordinates (x0, yi, F1) of the intersection point Psct at which the longitude line Lon crosses the y-grid line LY may be automatically determined by defining an operator which has a first-order equation of variable y making the parameter V zero (or converge to zero) using the Equation 2, the Equation 3 and the Equation 5. For example, the operator may use a Brent method. For example, the yi may be automatically determined by a repetition of numerical computation for the parameter V to be a value sufficiently close to zero within a predetermined error range.

Referring to FIG. 8D, an intersection point Psct at which a longitude line Lon crosses an x-grid line LX may be searched in a similar manner.

For example, if the longitude line Lon represents a equi-longitude line of λ=λ0, a third lat-lon grid point 610 may have a coordinates of (λ0, θ1) in the latitude-longitude coordinates system. Similarly, a fourth lat-lon grid point 620 may have a coordinates of (λ0, θ2) in the latitude-longitude coordinates system. If the x-grid line LX represents a equi-y-line of y=y0, a third cubed-sphere grid point 810 may have a coordinates of (x1, y0, F1) which is defined by an x-value, a y-value and a F-value in the cubed-sphere coordinates system. Similarly, a fourth cubed-sphere grid point 820 may have a coordinates of (x2, y0, F1). In this case, the intersection point Psct of the longitude line Lon and the x-grid line LX may have a coordinates of (xi, y0, F1), where xi denotes a real number between x1 and x2 (i.e., xiε[x1, x2]). Then, a root finding algorithm may be used in order to find the value of xi. The root finding algorithm may be used with the constant values of y0, F1 and λ0 to find a solution x=xi of a first-order equation.

For example, a cubed-sphere grid point (x, y, F1) in the first face F1 of the cubed-sphere grid coordinates system may be converted to a coordinates of (X, Y, Z) in a three-dimensional Cartesian coordinates system of which an origin is located at the center of the Earth by the above Equation 2.

The coordinates of (X, Y, Z) in the three-dimensional Cartesian coordinates system converted from the coordinates (x, y, F1) in the cubed-sphere coordinates system may be converted again to a coordinates of (λ, θ) in the latitude-longitude coordinates system by the above Equation 3.

By using the Equation 2 and the Equation 3 together, the coordinates (xi, y0, F1) of the intersection point Psct may be converted into a coordinates of (λnew, θnew) in the latitude-longitude coordinates system.

Then, by using the above Equation 5, the x-value which makes the parameter V zero (i.e., x=xi) may be determined among a real number interval of [x1, x2] because the intersection point Psct is located on the equi-longitude line of λ=λ0.

As mentioned above, the coordinates (xi, y0, F1) of the intersection point Psct at which the longitude line Lon crosses the x-grid line LX may be automatically determined by defining an operator which has a first-order equation of variable x making the parameter V zero (or converge to zero) using the Equation 2, the Equation 3 and the Equation 5. For example, the operator may use a Brent method. For example, the xi may be automatically determined by a repetition of numerical computation for the parameter V to be a value sufficiently close to zero within a predetermined error range.

Although the intersection point Psct is assumed to be located in the first face F1 in the above description, the intersection point Psct may also be located in another face (e.g., F2, F3, F4, F5 or F6) in the cubed-sphere coordinates system. In that case, a similar root finding algorithm may be used to find the intersection point Psct.

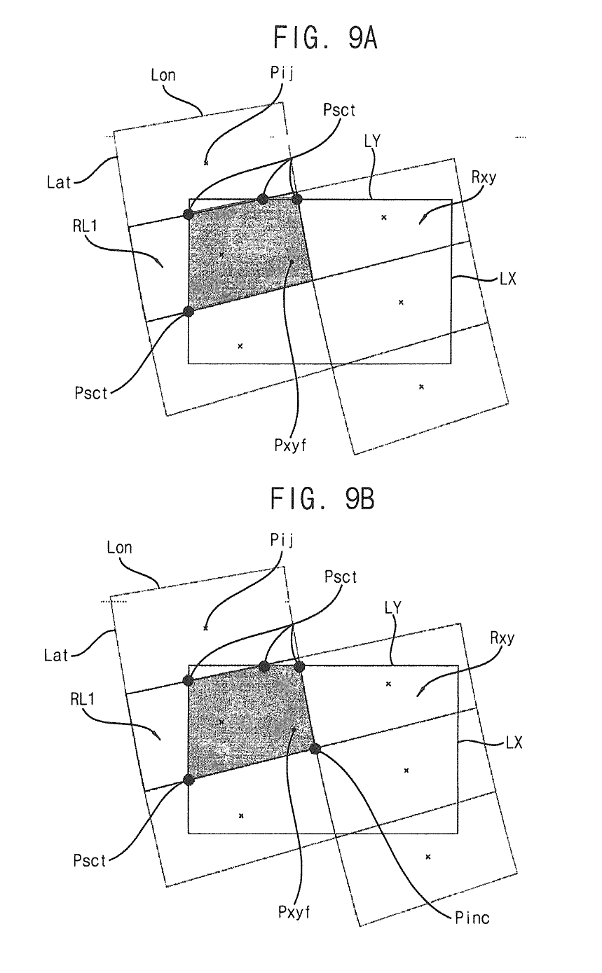

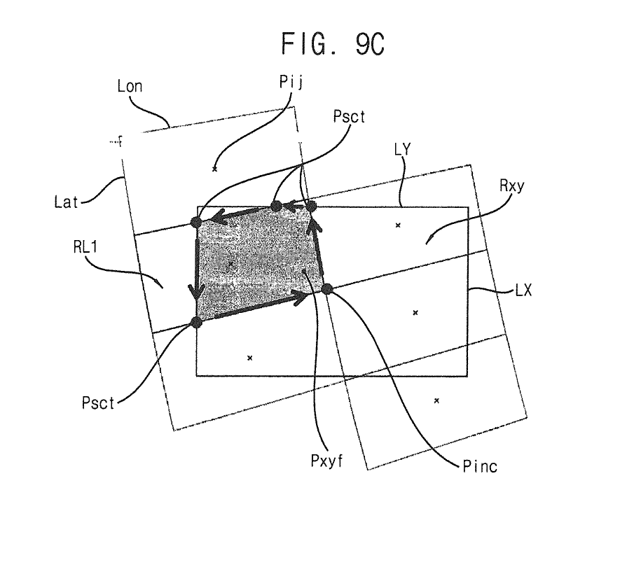

FIG. 9A, FIG. 9B and FIG. 9C are perspective views conceptually illustrating a fifth step to a seventh step performed in a coordinates conversion method of conservative physical parameters from a latitude-longitude coordinates system to a rotated cubed-sphere coordinates system according to an example embodiment of the invention.

Referring to FIG. 9A, in a filth step of the coordinates conversion method of conservative physical parameters from the latitude-longitude coordinates system to a rotated cubed-sphere coordinates system according to an example embodiment, intersection points Psct at which the x-grid lines LX or y-grid lines LY crosses the latitude lines Lat or the longitude lines Lon may be determined in order to find an area of an overlapping area between a first lat-lon area RL1 and a cubed-sphere grid area Rxy. Accordingly, a plurality of intersection points Psct (e.g., four intersection point in FIG. 9A) may be determined on the latitude lines Lat and the longitude lines Lon. The intersection points Psct may be searched by the root finding algorithm described in FIGS. 8A to 8D.

Referring to FIG. 9B, in a sixth step of the coordinates conversion method of conservative physical parameters from the latitude-longitude coordinates system to a rotated cubed-sphere coordinates system according to an example embodiment, a vertex point Pinc of the overlapping area located within the cubed-sphere grid area Rxy may be determined. For example, a single vertex point Pinc of the overlapping area may be determined within the cubed-sphere grid area Rxy.

Referring to FIG. 9C, in a seventh step of the coordinates conversion method of conservative physical parameters from the latitude-longitude coordinates system to a rotated cubed-sphere coordinates system according to an example embodiment, an area of the overlapping area may be computed using the intersection points Psct and the vertex point Pinc. For example, the area of the overlapping area may be computed by performing a line integral in a clockwise or a counterclockwise direction through a boundary line defined by the intersection points Psct and the vertex point Pinc. Accordingly, the area of the overlapping area between the first lat-lon area RL1 and the cubed-sphere grid area Rxy may be determined. By using the area of the overlapping area computed in the seventh step and the number of the overlapping areas acquired in the fourth step, a first value of a physical parameter in the latitude-longitude coordinates system may be converted to a second value of the physical parameter in the standard cubed-sphere coordinates system.

FIG. 10 is a perspective view illustrating a rotated cubed-sphere coordinates system converted from a latitude-longitude coordinates system according to an example embodiment of the invention.

Referring to FIG. 3 and FIG. 10, the standard cubed-sphere coordinates system may be rotated if a desired geographical region is divided by a plurality of faces in the standard cubed-sphere coordinates system. For example, the standard cubed-sphere coordinates system may be rotated for the Korean peninsula to be located substantially at a center of one of the faces in a cubed-sphere coordinates system. For example, the rotated cubed-sphere coordinate system may include a first rotated face Fr1 to a sixth rotated face Fr6. The Korean peninsula may be located at a center of the first rotated face Fr1. A second rotated face Fr2, a third rotated face and a fourth rotated face Fr4 may be sequentially disposed adjacent to the first rotated face Fr1 according to a rotational direction of the Earth. The rotated cubed-sphere coordinates system may include a fifth rotated face Fr5 including the north pole and a sixth rotated face Fr6 including the south pole. Although the Korean peninsula is located at the center of the first rotated face Fr1 in FIG. 10, the standard cubed-sphere coordinates system may be rotated for any geographical region on the Earth's surface to be located at a center of one of the rotated faces.

FIG. 11 is a perspective view illustrating axes of a rotated cubed-sphere coordinates system converted from a standard cubed-sphere coordinates system according to an example embodiment of the invention.

Referring to FIG. 11, the standard cubed-sphere coordinates system may be rotated one or more times to generate a rotated cubed-sphere coordinates system. For example, the standard cubed-sphere coordinates system may be rotated twice on its axes. For example, if the standard cubed-sphere coordinates system has an origin located at the center of the Earth and has an X-axis, a Y-axis and a Z-axis referred in a XYZ-standard cubed-sphere coordinates system, then the XYZ-standard coordinates system may be rotated on the Z-axis by an angle of λ0 to generate an X1-axis, a Y1-axis and a Z1-axis. In this case, the Z-axis is substantially the same as the Z1-axis because the Z-axis is the rotational axis. Then, the X1Y1Z1-rotated cubed-sphere coordinates system may be rotated on the Y1-axis by an angle of θ0 to generate an X2-axis, a Y2-axis and a Z2-axis. In this case, the Y1-axis is substantially the same as the Y2-axis because the Y1-axis is the rotational axis.

As a result, a position defined in a rotated coordinates system may be represented by using an inverse matrix of a conversion matrix based on Equation 6 to Equation 9

$${R}_{Z} ( {λ}_{0} ) = ( \begin{matrix}cos {λ}_{0} & sin {λ}_{0} & 0 \\ - sin {λ}_{0} & cos {λ}_{0} & 0 \\ 0 & 0 & 1\end{matrix} ) , \qquad [ Equation 6 ]$$

where λ0 denotes a rotational angle on the Z-axis,

$${R}_{Y} ( {θ}_{0} ) = ( \begin{matrix}cos {θ}_{0} & 0 & sin {θ}_{0} \\ 0 & 1 & 0 \\ - sin {θ}_{0} & 0 & cos {θ}_{0}\end{matrix} ) , \qquad [ Equation 7 ]$$

where θ0 denotes a rotational angle on the Y-axis,

$$\begin{matrix}{R}_{YZ} ( {θ}_{0} , {λ}_{0} ) = {R}_{Y} ( {θ}_{0} ) {R}_{Z} ( {λ}_{0} ) \\ = ( \begin{matrix}cos {θ}_{0} & 0 & sin {θ}_{0} \\ 0 & 1 & 0 \\ - sin {θ}_{0} & 0 & cos {θ}_{0}\end{matrix} ) ( \begin{matrix}cos {λ}_{0} & sin {λ}_{0} & 0 \\ - sin {λ}_{0} & cos {λ}_{0} & 0 \\ 0 & 0 & 1\end{matrix} ) \\ = ( \begin{matrix}cos {θ}_{0} cos {λ}_{0} & cos {θ}_{0} sin {λ}_{0} & sin {θ}_{0} \\ - sin {λ}_{0} & cos {λ}_{0} & 0 \\ - sin {θ}_{0} cos {λ}_{0} & - sin {θ}_{0} sin {λ}_{0} & cos {θ}_{0}\end{matrix} ) ,\end{matrix} \qquad [ Equation 8 ]$$

where R_{YZ} denotes a rotational conversion matrix sequentially applying a first rotation on the Z-axis and a second rotation on the Y-axis, and

$${R}_{YZ}^{- 1} ( {θ}_{0} , {λ}_{0} ) = ( \begin{matrix}cos {θ}_{0} cos {λ}_{0} & - sin {λ}_{0} & - sin {θ}_{0} cos {λ}_{0} \\ cos {θ}_{0} sin {λ}_{0} & cos {λ}_{0} & - sin {θ}_{0} sin {λ}_{0} \\ sin {θ}_{0} & 0 & cos {θ}_{0}\end{matrix} ) , \qquad [ Equation 9 ]$$

where R_{YZ}⁻¹ denotes an inverse matrix of R_{YZ}.

Accordingly, by applying the inverse matrix of the Equation 9 to the second value of the physical parameter in the standard cubed-sphere coordinates system, a third value of the physical parameter may be conservatively computed in a rotated cubed-sphere coordinates system such as e.g., the rotated cubed-sphere coordinates system which includes the Korean peninsula at a center of one of the faces.

FIG. 12 is a block diagram illustrating a computation part in a hardware device performing a coordinates conversion system of conservative physical parameters from a latitude-longitude coordinates system to a rotated cubed-sphere coordinates system according to an example embodiment of the invention.

Referring to FIG. 1 and FIG. 12, the computation part 130 in the hardware device 100 may include a master computation part 130M and a slave computation part 130S. The slave computation part 130S may include a first slave computation part 130s1 and a second slave computation part 130s2 to an i-th slave computation part 130si.

The master computation part 130M may be configured to allocate a desired computation work load to each of the slave computation parts 130s1 and 130s2 to 130si. For example, the master computation part 130M may allocate a first work load for computing a number and an area of overlapping areas between lat-lon areas and a first cubed-sphere grid area to the first slave computation part 130s1. The slave master computation part 130M may allocate a second work load for computing a number and an area of overlapping areas between lat-lon areas and a second cubed-sphere grid area to the second slave computation part 130s2. If the first cubed-sphere grid area is located in a mid-latitude region as illustrated in FIG. SC and the second cubed-sphere grid area is located in a polar region as illustrated in FIG. 5B, a first computation time to finish the first work load may be relatively shorter than a second computation time to finish the second work load. Accordingly, the first slave computation part 130s1 may finish the first work load before the second slave computation part 130s2 finishes the second work load. In this case, the master computation part 130M may be configured to further allocate a third work load for computing a number and an area of overlapping areas between lat-lon areas and a third cubed-sphere grid area to the first slave computation part 130s1. Similarly, the master computation part 130M may be configured to check a completion of a work load allocated in each of the slave computation part 130S to adequately distribute component work loads among a whole work load to the slave computation part 130S. Accordingly, a computing time may be reduced to convert a first value of a physical parameter in the latitude-longitude coordinates system into a second value of the physical parameter in the standard cubed-sphere coordinates system and then into a third value of the physical parameter in the rotated cubed-sphere coordinates system.

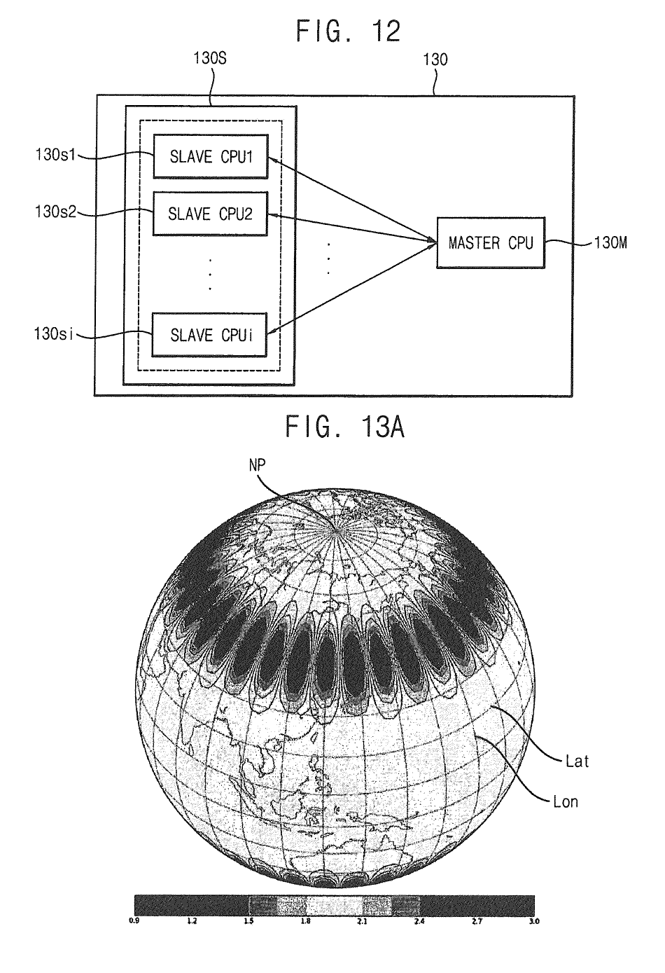

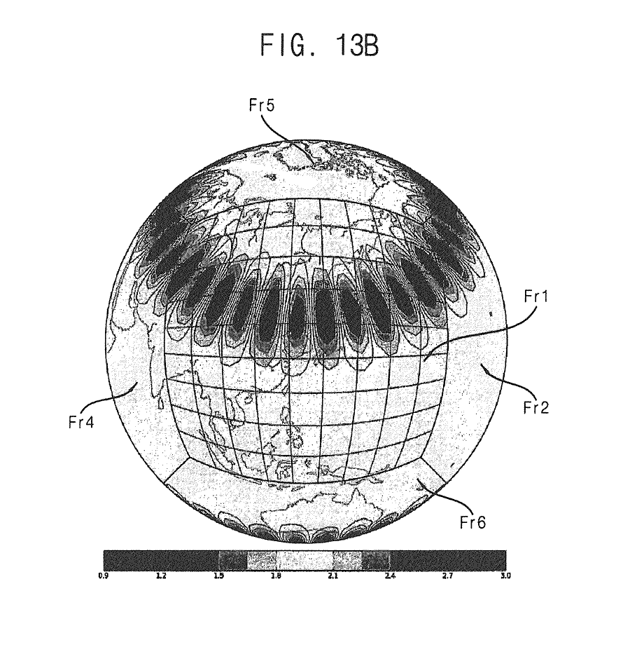

FIG. 13A is a perspective view illustrating a distribution of an atmospheric physical parameter using a conventional latitude-longitude coordinates system. FIG. 13B is a perspective view illustrating a distribution of an atmospheric physical parameter using a rotated cubed-sphere coordinates system converted from a latitude-longitude coordinates system according to an example embodiment of the invention.

Referring to FIG. 13A, if a numerical weather prediction model uses a conventional latitude-longitude coordinates system to represent a distribution of an atmospheric physical parameter, a local distribution of the atmospheric physical parameter may be enlarged near an equatorial region while a local distribution of the atmospheric physical parameter is reduced near a polar region. The difference of the local distributions between the equatorial region and the polar region may be due to different grid point resolutions in those regions in the latitude-longitude coordinates system.

Referring to FIG. 13B, if a numerical weather prediction model uses a rotated cubed-sphere coordinates system to represent a distribution of an atmospheric physical parameter, a local distribution of the atmospheric physical parameter in an equatorial region may be represented to have relatively uniform grid point resolution as that in a polar region. Also by using the rotated cubed-sphere coordinates system including a face in which a desired geographical region is centered, a local distribution of an atmospheric and/or an oceanic physical parameter near the desired geographical region may be well represented, thereby reducing sharp changes in the local distribution of the physical parameter due to a border line between faces.

As mentioned above, according to one or more example embodiment of the coordinates conversion method of conservative physical parameters from a latitude-longitude coordinates system to a rotated cubed-sphere coordinates system and the hardware device performing the same, a first value of a physical quantity defined in a conventional latitude-longitude coordinates system in a numerical weather prediction model may be conservatively converted to a second value of the physical quantity defined in a standard cubed-sphere coordinates system and then may be conservatively converted to a third value of the physical quantity defined in a rotated cubed-sphere coordinates system, thereby capable of automatic computation of a numerical solution of the numerical weather prediction model in a desired geographical region.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present invention. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

### EXPLANATION ON REFERENCE NUMERALS

| | |
|---|---|
| 100: hardware device | 110: memory |
| 130: computation part | 130M: master computation part |
| 130S: slave computation part | |
| F1, F2, F3, F4, F5, F6: face | |
| Pij: latitude-longitude center point | |
| Pxyf: grid center point | |
| Rb: boundary latitude-longitude area | |
| RL: latitude-longitude area | |
| Rxy: cubed-sphere grid area | |
| Rv1, Rv2, Rv3, Rv4: vertex area | |

What is claimed is:

1. A method of converting coordinates of a physical quantity from a latitude-longitude coordinates system to a rotated cubed-sphere coordinates system, wherein the method performed in a hardware device comprising a computation part and a memory electrically connected to the computation part, the computation part comprising a plurality of computing units, and the method comprising;
determining a plurality of latitude-longitude grid areas which overlap a cubed-sphere grid area; and
computing an overlapping area between the cubed-sphere grid area and the latitude-longitude grid areas,
wherein the determining the latitude-longitude grid areas which overlap the cubed-sphere grid area comprises:
determining a plurality of vertex areas among the latitude-longitude grid areas, the vertex areas comprising first vertex points of the cubed-sphere grid area respectively;
determining first intersection points at which a latitude grid line or a longitude grid line crosses a cubed-sphere grid line, the first intersection points being located between the vertex areas;
determining a plurality of boundary latitude-longitude grid areas among the latitude-longitude grid areas, the boundary latitude-longitude grid areas being directly adjacent to each of the first intersection points; and
determining a plurality of inner latitude-longitude grid areas among the latitude-longitude grid areas, the inner latitude-longitude grid areas being surrounded by the vertex areas and the boundary latitude-longitude grid areas,
wherein the determining the first intersection points at which the latitude grid line or the longitude grid line crosses the cubed-sphere grid line comprises:
converting first coordinates of the vertex points of the cubed-sphere grid area defined in a cubed-sphere coordinates system into second coordinates defined in a three-dimensional Cartesian coordinates system;
converting the second coordinates defined in the three-dimensional Cartesian coordinates system into third coordinates defined in the latitude-longitude coordinates system; and
defining a parameter by a difference between one of values of the third coordinates and a latitude value of an equi-latitude grid line or a longitude value of an equi-longitude grid line, and
wherein the first intersection points are determined by points which make the parameter close to zero in a predetermined error range respectively.

2. The method of claim 1, wherein the computing the overlapping area between the cubed-sphere grid area and the latitude-longitude grid areas comprises:
determining second intersection points at which the latitude grid line or the longitude grid line crosses the cubed-sphere grid line, the second intersection points being located in one of the latitude-longitude grid areas;
determining second vertex points of the one of the latitude-longitude grid areas, the second vertex points being located within the cubed-sphere grid area; and
numerically computing a line integral along a closed line which connects the second intersection points and the second vertex points in a clockwise direction or a counterclockwise direction.

3. The method of claim 2, wherein at least one of the first intersection points coincides with one of the second intersection points.

4. The method of claim 2 further comprising:
converting coordinates of the physical quantity represented in the cubed-sphere coordinates system into coordinates in a rotated cubed-sphere coordinates system, the rotated cubed-sphere coordinates system being rotated on one of a first axis, a second axis and a third axis which define the cubed-sphere coordinates system.

5. The method of claim 4, wherein the rotated cubed-sphere coordinates system is rotated on the first axis in a first rotation and further rotated on a fourth axis to which the second axis changes by the first rotation.

6. A hardware device comprising:
a computation part configured to determine a plurality of latitude-longitude grid areas overlapping a cubed-sphere grid area and compute overlapping areas between the cubed-sphere grid area and the latitude-longitude grid areas; and
a memory electrically connected to the computation part,
wherein the computation part is further configured to determine a plurality of vertex areas among the latitude-longitude grid areas, first intersection points at which a latitude grid line or a longitude grid line crosses a cubed-sphere grid line, a plurality of boundary latitude-longitude grid areas among the latitude-longitude grid areas and a plurality of inner latitude-longitude grid areas among the latitude-longitude grid areas,
wherein the vertex areas comprise first vertex points of the cubed-sphere grid area respectively, the first intersection points are located between the vertex areas, the boundary latitude-longitude grid areas are directly adjacent to each of the first intersection points and the inner latitude-longitude grid areas are surrounded by the vertex areas and the boundary latitude-longitude grid areas,
wherein the first intersection points are determined by points which make a parameter close to zero in a predetermined error range respectively,
wherein the parameter is defined by a difference between one of values of second coordinates and a latitude value of an equi-latitude grid line or a longitude value of an equi-longitude grid line,
wherein the second coordinates are defined in the latitude-longitude coordinates system and are converted from first coordinates of the vertex points of the cubed-sphere grid area defined in a cubed-sphere coordinates system via a three-dimensional Cartesian coordinates system.

7. The hardware device of claim 6, wherein the computation part is further configured to determine second vertex points of the one of the latitude-longitude grid areas and second intersection points at which the latitude grid line or the longitude grid line crosses the cubed-sphere grid line, and the computation part is configured to numerically compute a line integral along a closed line which connects the second intersection points and the second vertex points in a clockwise direction or a counterclockwise direction, and
wherein the second intersection points are located in one of the latitude-longitude grid areas and the second vertex points are located within the cubed-sphere grid area.

8. The hardware device of claim 7, wherein the computation part is further configured to convert coordinates of a physical quantity represented in the cubed-sphere coordinates system into coordinates in a rotated cubed-sphere coordinates system, and
wherein the rotated cubed-sphere coordinates system is rotated on one of a first axis, a second axis and a third axis which define the cubed-sphere coordinates system.

9. The hardware device of claim 8, wherein the rotated cubed-sphere coordinates system is rotated on the first axis in a first rotation and is further rotated on a fourth axis to which the second axis changes by the first rotation.

10. The hardware device of claim 6, wherein the computation part comprises:
a slave computation part comprising a plurality of slave computing units; and
a master computation part configured to allocate a plurality of work loads to the slave computing units,
wherein the master computation part is configured to allocate a first work load for computing overlapping areas between first latitude-longitude grid areas and a first cubed-sphere grid area to a first slave computing unit, and the master computation part is further configured to allocate a second work load for computing overlapping areas between second latitude-longitude grid areas and a second cubed-sphere grid area to a second slave computing unit.

11. The hardware device of claim 10, wherein the master computation part is further configured to allocate a third work load for computing overlapping areas between third latitude-longitude grid areas and a third cubed-sphere grid area to the first slave computing unit if the first slave computing unit finishes the first work load while the second slave computing unit processes the second work load.
